(19) United States
(12) Patent Application Publication
(10) Pub. No.: US 2017/0282186 A1
(43) Pub. Date: Oct. 5, 2017

(54) STRUCTURE FOR INTEGRATING MICROFLUIDIC DEVICES AND OPTICAL BIOSENSORS

(71) Applicants: CHIP WIN TECHNOLOGY CO., LTD., Hsinchu County (TW); ALF INTERNATIONAL CO., LTD., Anguilla (AI)

(72) Inventors: CHAO-CHING YU, Hsinchu County (TW); LIN-TA CHUNG, Hsinchu County (TW); HSI-YING YUAN, Hsinchu County (TW); KE-PAN LIAO, Hsinchu County (TW)

(21) Appl. No.: 15/352,705

(22) Filed: Nov. 16, 2016

(30) Foreign Application Priority Data
Mar. 31, 2016 (TW) 105110409

(51) Int. Cl. B01L 9/00

(52) U.S. Cl. CPC B01L 9/527; B01L 2200/027

(57) ABSTRACT

The present invention provides a structure for integrating microfluidic devices and optical biosensors, including: a holder member for carrying and receiving an optical biosensor; microfluidic channel layer for providing at least a fluid to flow; and a cover member for the inflow and outflow of the at least a fluid, the at least a fluid flowing from an inlet, passing the optical biosensor by at least a fluid channel for sensing, and then flowing out through at least one fluid outlet. As such, the integrating structure of the present invention can detect the optical signal produced by the optical biosensor, transport fluid, and avoid leakage, and is applicable to the integration of various forms of optical biosensors and microfluidic devices.

### CROSS-REFERENCE TO RELATED APPLICATION

This application claims the priority of Taiwanese patent application No. 105110409, filed on Mar. 31, 2016, which is incorporated herewith by reference.

### BACKGROUND

### 1. Field of the Invention

The technical field generally relates to a structure for integrating microfluidic devices and optical biosensors.

### 2. The Prior Arts

With the continuous development of electronic technology, the applications expand into cross-discipline exploration and integration, wherein the emergence of biosensors is considered a major breakthrough in the rapid development of biological or medical technology. A biosensor is generally defined as a device comprising an immobilized biomolecule binding a transducer or biochip to detect or interact with a chemical or biomolecule in vivo or in vitro to generate a response.

Biosensors fulfill many of the important measurement needs, particularly in the determination of drug, metabolic interactions with other biomolecules. While conventional analytical instruments can achieve similar goals, the most unique feature of biosensors is the high sensitivity, specificity, or selectivity of biosensors and the real-time detection characteristics of biomolecules. The reason is that the organism itself has a variety of chemical receptors, in other words, the organism itself is actually a collection of chemoreceptors, and the chemoreceptors have a high degree of specificity or selectivity and sensitivity. As biosensor technology matures, more and more forms of biosensors are on the market, wherein the biosensor combined with optical mechanism shows great potential in application of detecting protein, nucleic acid or other biochemical molecules.

On the other hand, adding the mechanic components required in conventional biochemical analysis in a form of micro-pumps, micro-valves, micro-filters, micro-mixers, micro-channels, micro-sensors and micro-reactors to the microfluidic devices for sample pre-processing, mixing, transporting, separation and detection procedures has also be actively applied to the biosensor. The applications cover, such as, new drug development, biological and medical research, health examination, disease detection, infection pathogen detection, blood screening and other clinical testing, or even non-medical fields, such as, national defense military detection, forensic identification, environmental and food inspection, and so on.

However, the known integrated structures of biosensors and microfluidic devices are often unable to provide quality uniformity, structural integrity, and process throughput for detection modules due to limitations of applications and existing integration manufacturing processes. Therefore, it is desirable to provide an effective and flexible application of optical biosensor and microfluidic device integration structure to respond to the market needs.

### SUMMARY

An embodiment of the present invention discloses a structure for integrating microfluidic devices and optical biosensors, comprising: a carrier, disposed with at least a recess for carrying and accommodating at least an optical biosensor, wherein the optical biosensor having a biosensor layer; a flow channel layer, disposed on top of the carrier and comprising at least a channel for at least a fluid to flow; and a cover member, disposed on top of the flow channel layer and having at least a fluid inlet and at least a fluid outlet for the inflow and outflow of the at least a fluid, the at least a fluid inlet and the at least a fluid outlet being connected to the at least a channel of the flow channel layer, wherein the at least a fluid flowing in from the at least a fluid inlet, through the at least a channel to the biosensor layer of the optical biosensor thereon for sensing and out of the at least a fluid outlet.

Another embodiment of the present invention discloses a structure for integrating microfluidic devices and optical biosensors, comprising: a carrier, disposed with at least a recess for carrying and accommodating at least an optical biosensor, wherein the optical biosensor having a first biosensor layer and a second biosensor layer; an upper flow channel layer, disposed on top of the carrier and comprising at least a first channel for at least a first fluid to flow; a lower flow channel layer, disposed below the carrier and comprising at least a second channel for at least a second fluid to flow; an upper cover member, disposed on top of the upper flow channel layer, and having at least a first fluid inlet and at least a first fluid outlet for the inflow and outflow of the at least a first fluid, the at least a first fluid inlet and the at least a first fluid outlet being connected to the at least a first channel of the upper flow channel layer; and a lower cover member, disposed below the lower flow channel layer and having at least a second fluid inlet and at least a second fluid outlet for the inflow and outflow of the at least a second fluid, the at least a second fluid inlet and the at least a second fluid outlet being connected to the at least a second channel of the lower flow channel layer; wherein the at least a first fluid and the at least a second fluid flowing in respectively from the at least a first fluid inlet of the upper cover member and the at least a second fluid inlet of the lower cover member, and then respectively through the at least a first channel to the first biosensor layer of the optical biosensor thereon for sensing and through the at least a second channel to the second biosensor layer of the optical biosensor thereon for sensing, and finally out respectively from the at least a first fluid outlet of the upper cover member and the at least a second fluid outlet of the lower cover member.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a first embodiment of the structure for integrating microfluidic devices and optical biosensors in accordance with an exemplary embodiment;

FIG. 2 shows cross-sectional view of the first embodiment of the structure for integrating microfluidic devices and optical biosensors in accordance with an exemplary embodiment; and

FIG. 3 shows a cross-sectional view of a second embodiment of the structure for integrating microfluidic devices and optical biosensors in accordance with an exemplary embodiment.

### DETAILED DESCRIPTION OF THE PREFERRED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

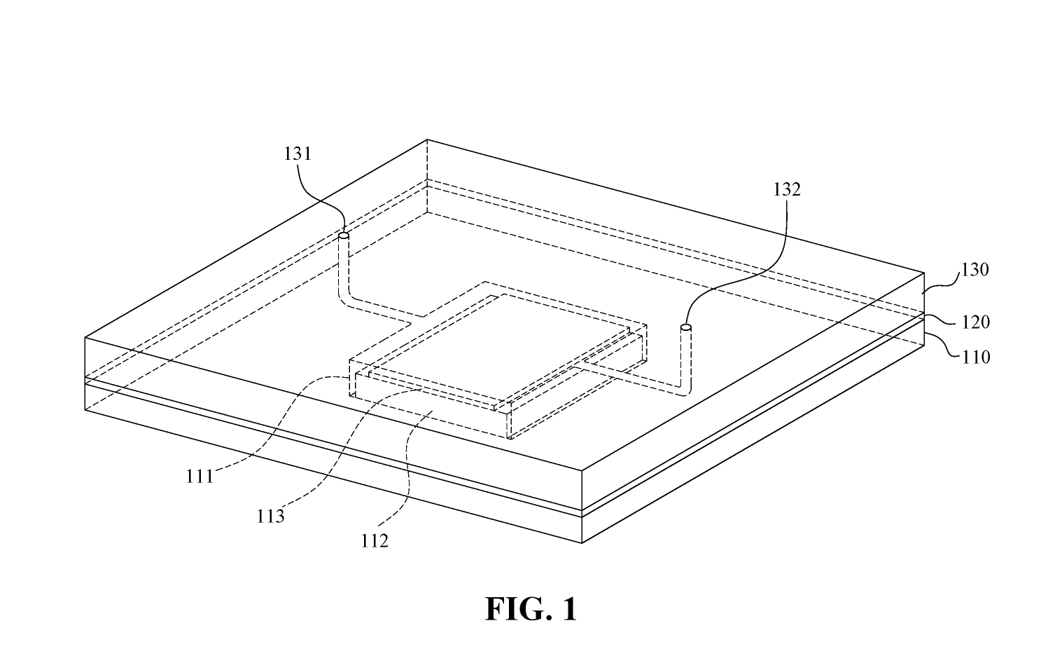

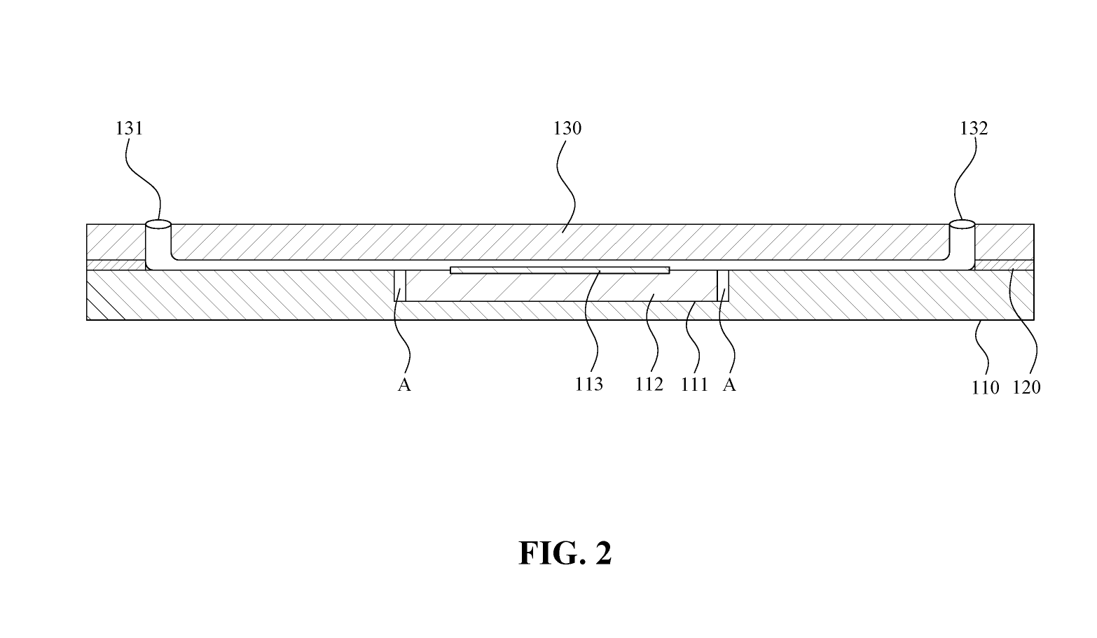

Refer to FIGS. 1-2. FIG. 1 shows a schematic view of a first embodiment of the structure for integrating microfluidic devices and optical biosensors in accordance with an exemplary embodiment; and FIG. 2 shows cross-sectional view of the first embodiment of the structure for integrating microfluidic devices and optical biosensors in accordance with an exemplary embodiment. The structure for integrating microfluidic devices and optical biosensors is applied to form an integrated module comprising at least a optical biosensor and at least a microfluidic devices. As shown in FIGS. 1-2, the structure for integrating microfluidic devices and optical biosensors comprises, from bottom up: a carrier 110, a flow channel layer 120 and a cover member 130.

The carrier 110 is disposed with at least a recess 111 for carrying and accommodating at least an optical biosensor 112, wherein the optical biosensor 112 has a biosensor layer 113. The flow channel layer 120 is disposed on top of the carrier 110 and comprises at least a channel for at least a fluid to flow. The cover member 130 is disposed on top of the flow channel layer 120 and has at least a fluid inlet 131 and at least a fluid outlet 132 for the inflow and outflow of the at least a fluid; the at least a fluid inlet 131 and the at least a fluid outlet 132 are connected to the at least a channel of the flow channel layer 120, wherein the at least a fluid flows in from the at least a fluid inlet 131, through the at least a channel to the biosensor layer 113 of the optical biosensor 112 thereon for sensing and out of the at least a fluid outlet 132.

It should be noted that, in a preferred embodiment, the optical biosensor 112 is secured within the recess 111 of the carrier 110 using an adhesive means (A). Moreover, the upper surface of the optical biosensor 112, when placed inside the recess 111, is at the same horizontal level as the upper surface of the carrier 110. The recess 111 may be a concave surface, a concave portion, or a hollow via. The carrier 110 may be made of a transparent or opaque material, for example, a polymeric material, plastic, ceramic, metal, silicon wafer, glass, or other composite material. When the carrier 110 is made of an opaque material, the carrier 110 is provided with a light transmission window (not shown); and the light transmission window is aligned with the biosensor layer 113 of the optical biosensor 112 when the optical biosensor is placed inside the recess 111. This is because the optical biosensor requires exposure to light for reaction. The light transmission window may be covered by a transparent material or simply an opening.

Similarly, flow channel layer 120 may be made of a transparent or opaque material such as, polymeric material, plastic, ceramic, metal, silicon wafer, glass, or other composite material. The surface of the flow channel layer 120 may be processed to a hydrophilic or hydrophobic surface. The flow channel layer 120 may further comprise at least a pump element, at least a valve element, at least a mixer element, other microfluidic element, or any combination thereof for the flow and pretreatment of at least a fluid. Furthermore, the flow channel layer 120 may also be a multi-layer structure having a plurality of layers whose surfaces may be processed to show hydrophilic or hydrophobic characteristics.

The cover member 130 may be made of a transparent material or an opaque material such as, polymeric material, plastic, ceramic, metal, silicon wafer, glass, or other composite material. When the cover member 130 is made of an opaque material, the cover member 130 is provided with a light transmission window (not shown) which, after covering, is aligned with the biosensor layer 113 of the optical biosensor 112. The light transmission window may be covered by a transparent material or simply an opening. Further, the flow channel layer 120 and the cover member 130 may be integrated into one piece, or the flow channel layer 120 and the carrier 110 may be integrated into an integrally formed structure to reduce the subsequent encapsulation or assembly process.

It should be noted that since the optical biosensor 112 needs illumination to excite the optical signal of the biosensor layer and to receive the sensed optical signal sensed, an additional light transmission window aligned with the optical biosensor 112 must be provided when the carrier 110 or the cover 130 is made of an opaque material, for the illumination to enter and the optical signal generated to be sensed. In the embodiment shown in FIGS. 1-2, the carrier 110 and the cover member 130 are made of a transparent material. Moreover, the junctions between the components in the structure of the present invention, with the exception of the channel, such as the carrier 110, the biosensor layer 113, the flow channel layer 120, and the cover member 130, must be leakage-proof to prevent fluid leakage.

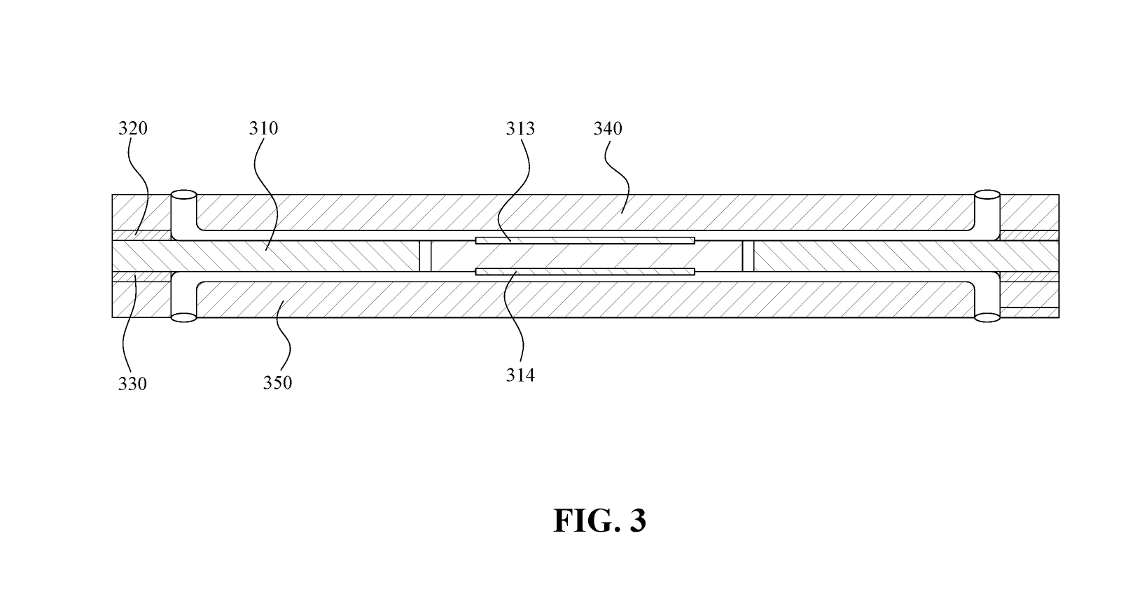

FIG. 3 shows a cross-sectional view of a second embodiment of the present invention. As shown in FIG. 3, the second embodiment of the structure for integrating microfluidic devices and optical biosensors comprises: a carrier 310, an upper flow channel 320, a lower flow channel layer 330, an upper cover member 340 and a lower cover member 350.

The carrier 310 is disposed with at least a recess for carrying and accommodating at least an optical biosensor, wherein the optical biosensor has a first biosensor layer and a second biosensor layer. The upper flow channel layer 320 is disposed on top of the carrier 310 and comprises at least a first channel for at least a first fluid to flow; and the lower flow channel layer 330 is disposed below the carrier 310 and comprises at least a second channel for at least a second fluid to flow. The upper cover member 340 is disposed on top of the upper flow channel layer 320, and has at least a first fluid inlet and at least a first fluid outlet for the inflow and outflow of the at least a first fluid; and the at least a first fluid inlet and the at least a first fluid outlet are connected to the at least a first channel of the upper flow channel layer 320. Similarly, the lower cover member 350 is disposed below the lower flow channel layer 330 and has at least a second fluid inlet and at least a second fluid outlet for the inflow and outflow of the at least a second fluid; and the at least a second fluid inlet and the at least a second fluid outlet are connected to the at least a second channel of the lower flow channel layer. Accordingly, the at least a first fluid flows in from the at least a first fluid inlet of the upper cover member, through the at least a first channel of the upper flow channel layer 320 to the first biosensor layer of the optical biosensor thereon for sensing, and finally out from the at least a first fluid outlet of the upper cover member 330. Similarly, the at least a second fluid flows in from the at least a second fluid inlet of the lower cover member, through the at least a second channel of the lower flow channel layer 340 to the second biosensor layer of the optical biosensor thereon for sensing, and finally out from the at least a second fluid outlet of the lower cover member 350.

It should be noted that the second embodiment is similar to the first embodiment, with the difference that the first embodiment uses a three-layered structure while the second embodiment uses a five-layered structure. By disposing the upper and lower flow channel layers 320, 330 and the upper and lower cover members 340, 350 on top of and below the carrier 310 respectively, the second embodiment allows two fluids to enter from the top and from below, and thus can be applied to more complex processes that requires multiple sensing reactions. The structure and functions of the components are similar to the counterparts in the first embodiment, and the detailed description will not be repeated.

In summary, the structure for integrating microfluidic devices and optical biosensors of the present invention is able to detect the optical signal generated by the optical biosensors. Moreover, the junctions between the components in the structure, with the exception of the channel, are able to isolate fluid to prevent fluid leakage. Hence, the structure of the present invention is applicable to various optical biosensors and microfluidic devices.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A structure for integrating microfluidic devices and optical biosensors, comprising:
a carrier, disposed with at least a recess for carrying and accommodating at least an optical biosensor, wherein the optical biosensor having a biosensor layer;
a flow channel layer, disposed on top of the carrier and comprising at least a channel for at least a fluid to flow; and
a cover member, disposed on top of the flow channel layer and having at least a fluid inlet and at least a fluid outlet for the inflow and outflow of the at least a fluid, the at least a fluid inlet and the at least a fluid outlet being connected to the at least a channel of the flow channel layer;
wherein the at least a fluid flowing in from the at least a fluid inlet, through the at least a channel to the biosensor layer of the optical biosensor thereon for sensing and out of the at least a fluid outlet.

2. The structure for integrating microfluidic devices and optical biosensors as claimed in claim 1, wherein the optical biosensor is fixed within the recess of the carrier using an adhesive means, and the recess is a concave surface, a concave portion, or a hollow via.

3. The structure for integrating microfluidic devices and optical biosensors as claimed in claim 1, wherein the upper surface of the optical biosensor is at the same horizontal level as the upper surface of the carrier when placed inside the recess.

4. The structure for integrating microfluidic devices and optical biosensors as claimed in claim 1, wherein the carrier is provided with a light transmission window when the carrier is made of an opaque material, and the light transmission window is aligned with the biosensor layer of the optical biosensor with the optical biosensor fixed inside the recess; the light transmission window is a hollow opening or covered by a transparent material.

5. The structure for integrating microfluidic devices and optical biosensors as claimed in claim 1, wherein the surface of the flow channel layer is processed to become a hydrophilic or hydrophobic surface.

6. The structure for integrating microfluidic devices and optical biosensors as claimed in claim 1, wherein the flow channel layer further comprises at least a pump element, at least a valve element, at least a mixer element, other microfluidic element, or any combination thereof for the flow and pretreatment of at least a fluid.

7. The structure for integrating microfluidic devices and optical biosensors as claimed in claim 1, wherein the flow channel layer is a multi-layer structure having a plurality of layers whose surfaces is processed to become hydrophilic or hydrophobic.

8. The structure for integrating microfluidic devices and optical biosensors as claimed in claim 1, wherein the cover element is made of an opaque material and provided with a light transmission window, and the light transmission window is aligned with the biosensor layer of the optical biosensor with the optical biosensor fixed inside the recess; the light transmission window is a hollow opening or covered by a transparent material.

9. The structure for integrating microfluidic devices and optical biosensors as claimed in claim 1, wherein the flow channel layer and the cover member are integrated into a monolithic element, or the flow channel layer and the carrier are integrated into a monolithic element.

10. A structure for integrating microfluidic devices and optical biosensors, comprising:
a carrier, disposed with at least a recess for carrying and accommodating at least an optical biosensor, wherein the optical biosensor having a first biosensor layer and a second biosensor layer;
an upper flow channel layer, disposed on top of the carrier and comprising at least a first channel for at least a first fluid to flow;
a lower flow channel layer, disposed below the carrier and comprising at least a second channel for at least a second fluid to flow;
an upper cover member, disposed on top of the upper flow channel layer, and having at least a first fluid inlet and at least a first fluid outlet for the inflow and outflow of the at least a first fluid, the at least a first fluid inlet and the at least a first fluid outlet being connected to the at least a first channel of the upper flow channel layer; and
a lower cover member, disposed below the lower flow channel layer and having at least a second fluid inlet and at least a second fluid outlet for the inflow and outflow of the at least a second fluid, the at least a second fluid inlet and the at least a second fluid outlet being connected to the at least a second channel of the lower flow channel layer;
wherein the at least a first fluid and the at least a second fluid flowing in respectively from the at least a first fluid inlet of the upper cover member and the at least a second fluid inlet of the lower cover member, and then respectively through the at least a first channel to the first biosensor layer of the optical biosensor thereon for sensing and through the at least a second channel to the second biosensor layer of the optical biosensor thereon for sensing, and finally out respectively from the at least a first fluid outlet of the upper cover member and the at least a second fluid outlet of the lower cover member.

11. The structure for integrating microfluidic devices and optical biosensors as claimed in claim 10, wherein the optical biosensor is fixed within the recess of the carrier using an adhesive means, and the recess is a concave surface, a concave portion, or a hollow via.

12. The structure for integrating microfluidic devices and optical biosensors as claimed in claim 10, wherein the upper surface of the optical biosensor is at the same horizontal level as the upper surface of the carrier when placed inside the recess.

13. The structure for integrating microfluidic devices and optical biosensors as claimed in claim 10, wherein the carrier is provided with a light transmission window when the carrier is made of an opaque material, and the light transmission window is aligned with the biosensor layer of the optical biosensor with the optical biosensor fixed inside the recess; the light transmission window is a hollow opening or covered by a transparent material.

14. The structure for integrating microfluidic devices and optical biosensors as claimed in claim 10, wherein the surfaces of the upper and lower flow channel layers are processed to become hydrophilic or hydrophobic surfaces.

15. The structure for integrating microfluidic devices and optical biosensors as claimed in claim 10, wherein the upper and/or lower flow channel layers further comprises at least a pump element, at least a valve element, at least a mixer element, other microfluidic element, or any combination thereof for the flow and pretreatment of at least a fluid.

16. The structure for integrating microfluidic devices and optical biosensors as claimed in claim 10, wherein the upper and/or lower flow channel layers are a multi-layer structure having a plurality of layers whose surfaces is processed to become hydrophilic or hydrophobic.

17. The structure for integrating microfluidic devices and optical biosensors as claimed in claim 10, wherein the upper and lower cover elements are made of an opaque material and provided respectively with a first light transmission window and a second light transmission window, and the first and second light transmission windows are aligned respectively with the first and second biosensor layers of the optical biosensor with the optical biosensor fixed inside the recess; the first and second light transmission windows are hollow openings or covered by a transparent material.

18. The structure for integrating microfluidic devices and optical biosensors as claimed in claim 10, wherein the upper flow channel layer and the upper cover member are integrated into a monolithic element and the lower flow channel layer and the lower cover member are integrated into a monolithic element, or the upper flow channel layer, the carrier and the lower flow channel are integrated into a monolithic element.
